(19) United States
(12) Patent Application Publication
(10) Pub. No.: US 2018/0154961 A1
(43) Pub. Date: Jun. 7, 2018

(54) Variable Traction Device

(71) Applicant: Cameron Ray Woods, Soquel, CA (US)

(72) Inventor: Cameron Ray Woods, Soquel, CA (US)

(21) Appl. No.: 15/833,650

(22) Filed: Dec. 6, 2017

Related U.S. Application Data
(60) Provisional application No. 62/430,786, filed on Dec. 6, 2016.

(51) Int. Cl. B62D 61/12; B60T 11/08; B60T 7/10; B60T 11/10

(52) U.S. Cl. CPC B62D 61/12; B60T 11/08; B62D 21/183; B60T 11/102; B60T 7/102

(57) ABSTRACT

A variable traction device for drifting vehicles that allows the driver to vary the traction of the rear wheels with the road surface by alternating the weight of the drift vehicle between two sets of rear wheels with a substantially different coefficient of friction. The variable traction device includes a set of primary rear wheels, a set of secondary rear wheels, and an actuator lever. The actuator lever is located within reach of the driver and is operatively coupled to raise and lower the secondary rear wheels between a retracted position in which the vehicles weight is on the primary rear wheels and a deployed position in which the vehicles weight is on the secondary rear wheels. By manipulation of the actuator lever, it gives the driver the ability to vary the traction of the rear wheels with the road surface.

### CROSS REFERENCE TO RELATED APPLICATIONS

This application claims the benefit of Provisional Application No. 62430786 filed Dec. 6, 2016 by the present inventor, which is incorporated by reference.

### BACKGROUND OF THE INVENTION

The present invention relates to the field of recreational vehicles and, more particularly to vehicles used in the sport of drifting.

Drifting is a driving technique that is considered an “extreme” sport. Drifting is one of the fastest growing forms of motorsports in the world. As a motorsport discipline, professional drifting competitions are held worldwide and are judged according to the speed, angle, and showmanship.

Drifting is when a driver intentionally causes a vehicle to slide or ‘drift’ laterally. This is achieved by making a turn at speeds high enough to cause the rear tires to lose traction, or with enough power applied to the rear tires to make them lose traction, allowing the car to slide laterally. A car is said to be drifting when the rear slip angle is greater than the front slip angle, and the front wheels are pointing in the opposite direction to the turn.

Drift cars have high horsepower motors that are able to spin the rear wheels causing loss of traction which makes the car drift sideways. Drift trikes have low power motors or no motor at all so they are unable to rely on high horsepower to lose traction and drift. The rear wheels of drift trikes are mostly taken from go-kart wheels on which riders install hard plastic PVC sleeves which increases loss of traction (you do it intentionally), so it's easier to put you're trike into a drift. They are designed to drift, by intentionally initiating loss of traction to the rear wheels and counter-steering to negotiate corners. They are usually ridden on paved roads with steep downhill gradients, with corners and switchbacks. Operating speeds for drift trikes generally range between 25-50 mph. The sensation of sliding sideways during a controlled drift is what drivers are seeking when they drift.

Drift trikes are inherently dangerous due to the very thing that makes them slide—the plastic wheels. When negotiating turns down steep hills drift trikes sometimes are unable to make the turn and slide off the roadway and crash due to the speed is too high for the amount of grip of the plastic wheels. Various traction reducing and drifting apparatuses have been proposed and implemented for vehicles. All have used caster wheels to achieve the lateral sliding action, such as U.S. Pat. No. 4,998,594 and U.S. Pat. No. 7,823,675. These prior art devices achieve sliding by lifting the fixed wheels off the ground and letting the caster wheels steer the vehicle sideways. Caster wheels suffer from two main disadvantages. First, caster wheels simulate drifting by steering the rear end sideways which does not give the same “sensation” as a fixed wheel sliding sideways that drift vehicle drivers are looking for. Second, caster wheels are prone to speed wobbles or flutter above speeds of 15 mph due to their self steering nature. Caster flutter is a phenomenon in which a swivel caster is harmonically excited such that it begins to swing uncontrollably from side to side as the wheel rolls forward. All casters will flutter once it hits a certain velocity and is excited at its natural frequency. Caster wheels are generally only used to induce drift on low speed vehicles and children's toy drifting vehicles. High-performance drifting vehicles are sometimes travelling at speeds in excess of 50 mph.

### BRIEF SUMMARY OF THE INVENTION

It is therefore an object of the present invention to provide a variable traction device for drifting vehicles that allows for increased user safety when in operation by the driver. It is another object of the present invention to provide drift vehicle drivers with a variable traction device that allows drivers to have rear wheels that slide easily when they want to induce a drift in a turn, and to have rear wheels that grip when the driver needs to brake for an emergency, negotiate a turn, or for collision avoidance.

A variable traction device in accordance with an embodiment of the invention includes a pair of primary rear wheels, a pair of secondary rear wheels, and an actuator lever. One embodiment of the invention includes a rear axle to which the pair of primary rear wheels are rotatably mounted to opposite ends of the rear axle with the rear axle being pivotally attached to a drift vehicle chassis. A pair of swing-arms are rigidly attached to the rear axle at the outer ends near the primary rear wheels. The pair of secondary rear wheels are rotatably mounted to the distal end of the swing-arms. The actuator lever is mounted to the drift vehicle chassis within reach of the driver and is operably linked through a pushrod to a bell crank affixed to the rear axle, whereby pulling on the actuator lever rotates the rear axle lowering the secondary rear wheels to the ground. The secondary rear wheels are moveable between a retracted position (up) in which they are not in contact with the ground, and a fully deployed position (down) in which all of the weight of the drift vehicle/driver is on the secondary rear wheels with the primary rear wheels being lifted off of the ground. In one embodiment, the primary rear wheels are made of a material with a low coefficient of friction such as plastic, and the secondary rear wheels are made of a material with a high coefficient of friction such as rubber. Pulling or pushing on the actuator lever allows the driver to vary the traction of the rear wheels with the road surface by varying the weight of the vehicle between the primary rear wheels and the secondary rear wheels.

In another embodiment, the actuator lever is a hand lever mounted directly to the rear axle, eliminating the bell crank and the pushrod.

In still another embodiment, the actuator lever is a foot pedal mounted to the drift vehicle chassis which is mechanically connected to the bell crank with a pushrod.

In a further embodiment, the actuator lever is a hand lever which is mounted to the handlebars or steering wheel of the drift vehicle and is mechanically connected to the bell crank with a cable.

Various objects, features, aspects, and advantages of the present invention will become more apparent from the following detailed description of preferred embodiments of the invention, along with the accompanying drawings in which like numerals represent like components.

### BRIEF DESCRIPTION OF THE DRAWINGS

The accompanying drawings, which are incorporated in and constitute a part of the specification, illustrate an embodiment of the invention and, together with a general description given above and the detailed description of the preferred embodiment given below, serve to explain the principles of the invention.

FIG. 1 is a low-angle right-side perspective view of a variable traction device on a conventional drifting vehicle in accordance with a first embodiment of the invention, with the conventional drifting vehicle being shown in phantom line.

FIG. 2A and 2B are right-side views of the drifting vehicle shown in FIG.1, showing the secondary rear wheels in the retracted and deployed positions due to the pulling or pushing of the actuator lever in accordance with an embodiment of the invention.

FIG. 3 is a low-angle right-side perspective view of the variable traction device of FIG. 1 with the drifting vehicle not shown for better clarity.

FIG. 4 is a high-angle right-side perspective view of a variable traction device on a conventional drifting vehicle in accordance with a second embodiment of the invention showing the actuator lever directly attached to a rear axle.

FIG. 5 is a low-angle right-side perspective view of a variable traction device on a conventional drifting vehicle in accordance with a third embodiment of the invention showing a foot pedal as the actuator lever.

FIG. 6 is a high-angle top-side perspective view of a variable traction device on a conventional drifting vehicle in accordance with a fourth embodiment of the invention showing a hand lever mounted on the handlebars as the actuator lever.

FIG. 7A is a right-side perspective view of a variable traction device on a conventional drifting vehicle in accordance with a fifth embodiment of the invention, FIG. 7B is a top view of the embodiment shown in 7A.

FIG. 8A is a high-angle right-side perspective view of a variable traction device on a conventional drifting vehicle in accordance with a sixth embodiment of the invention, FIG. 8B is an enlarged view of a part of FIG. 8A.

FIG. 9 is a top view of a variable traction device on a conventional drifting vehicle in accordance with a seventh embodiment of the invention with a motor driven rear axle.

FIG. 10 is a right-side perspective view of the embodiment shown in FIG. 9

FIG. 11A and FIG. 11B are right-side views of the variable traction device shown in FIGS. 9 and 10 showing the secondary rear wheels in the retracted and deployed positions due to the pulling or pushing of the actuator lever.

FIG. 12 is a high-angle right-side perspective view of a variable traction device on a conventional drifting vehicle in accordance with an eighth embodiment of the invention having a hydraulic linked actuator lever.

### DETAILED DESCRIPTION OF THE INVENTION

Reference will now be made in detail to the present embodiments of the invention as illustrated in the accompanying drawings. In accordance with an embodiment of the invention, there is provided a variable traction device for drifting vehicles that allows the driver to vary the traction of the rear wheels by pulling or pushing on an actuator lever mounted on the drift vehicle. The drift vehicle can be any three or four wheeled vehicle that is designed for drifting, with or without a motor.

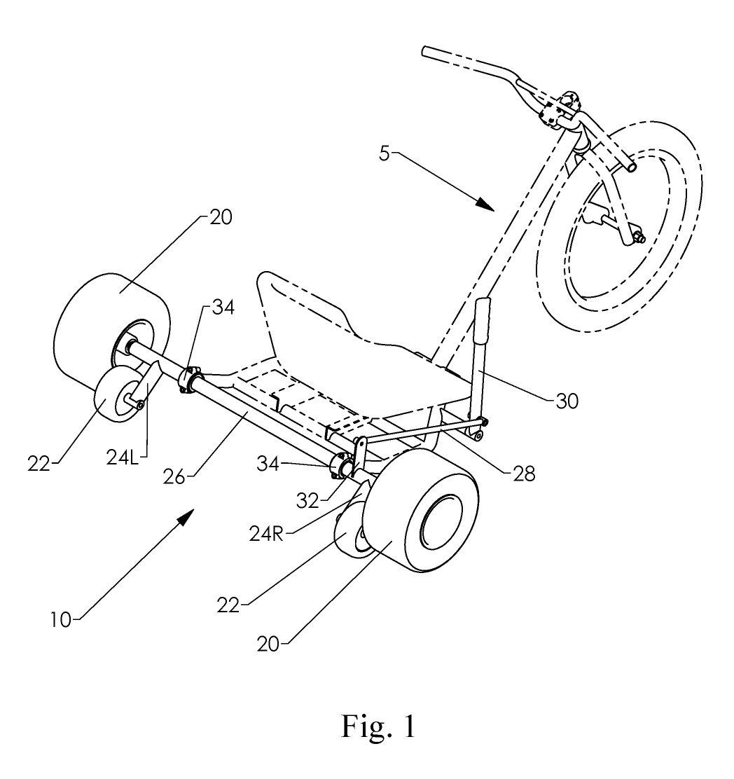

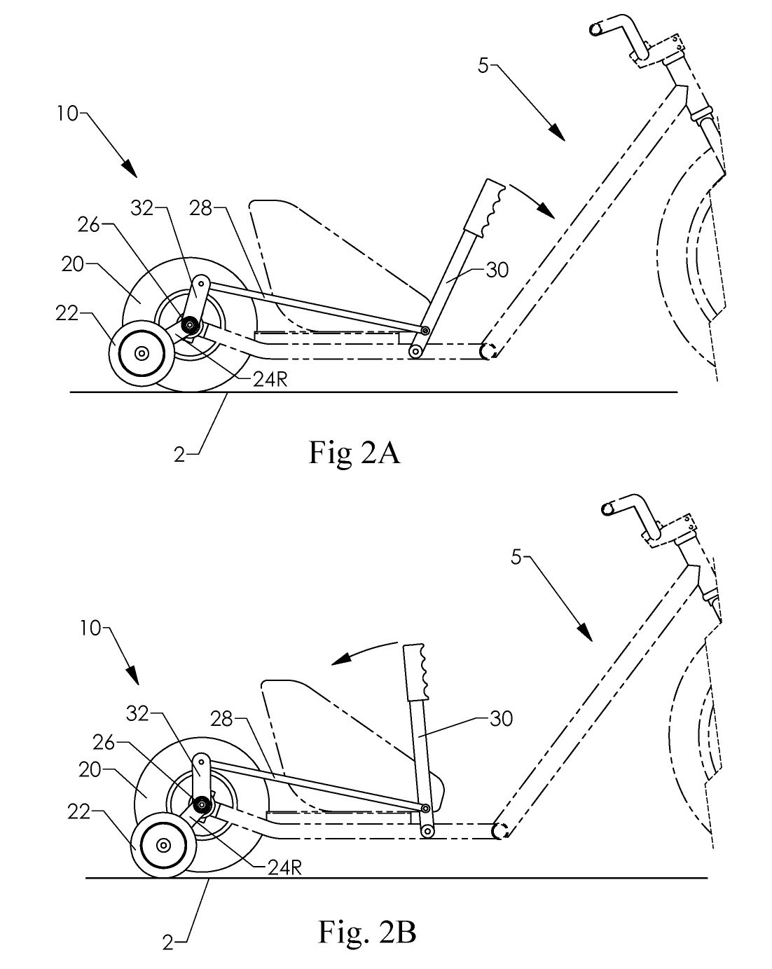

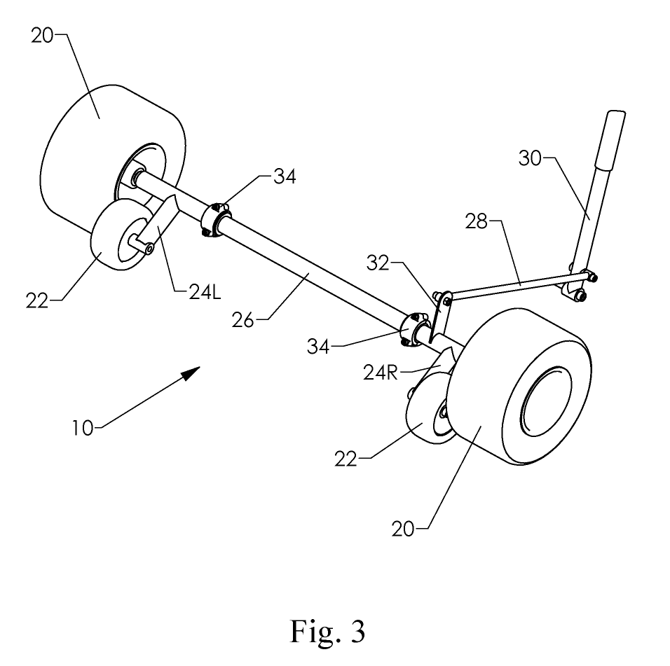

In FIG. 1, a variable traction device 10 (in solid line) is shown according to an embodiment of the invention on a conventional three-wheeled drift vehicle 5 (shown in phantom line), allowing the driver to vary the traction of primary rear wheels 20 by pulling or pushing on actuator lever 30. A mechanical linkage such as a push rod 28 operably links actuator lever 30 to a bell crank 32 which is affixed to an elongated rear axle 26, whereby pushing or pulling on actuator lever 30 will rotate rear axle 26. Rear axle 26 is pivotally secured with bearing means 34 journaling the axle. The width of rear axle 26 is typically 36 to 50 inch wide but is mostly dependent on the width of the vehicle. The primary rear wheels 20 are rotatably attached to opposite ends of the rear axle 26. Swing-arms 24L and 24R are affixed to rear axle 26 preferably near the primary rear wheels 20. A pair of secondary rear wheels 22 are rotatably attached to the distal end of swing-arms 24L and 24R. Rear axle 26 and swing-arms 24L and 24R are preferably made from a steel or aluminum alloy hollow tubing but could also be cast from solid material. FIG. 3 shows the components of the variable traction device 10 of FIG. 1-2B with the drift vehicle not shown for better clarity.

FIGS. 2A and 2B show the movement of the secondary rear wheels 22 in relation to the movement of the actuator lever 30. FIG. 2A shows the secondary rear wheels 22 in the fully retracted position, and FIG. 2B shows the secondary rear wheels in the fully deployed position. When the actuator lever 30 is pulled backwards, pushrod 28 pushes on bell crank 32 rotating rear axle 26 thereby rotating the distal end of swing-arms 24L and 24R downward, lowering secondary rear wheels 22 to the ground 2. When the actuator lever 30 is pulled with sufficient force, primary rear wheels 20 are lifted off of the ground 2 by the secondary rear wheels 22, as shown in FIG. 2B.

Primary rear wheels 20 and secondary rear wheels 22 are made from materials that have a dissimilar coefficient of friction. In the illustrated embodiment, the primary rear wheels 20 are made from a material with a low coefficient of friction such as plastic, nylon, acetal, PVC, polyethylene, or other materials that have a low amount of grip with the road surface. The secondary rear wheels 22 are made from a material with a high coefficient of friction such as rubber, polyurethane, neoprene, or other materials that have high amount of grip with the road surface. In an alternative embodiment, the primary rear wheels could be made from a material with a high coefficient of friction and the secondary rear wheels could be made from a material with a low coefficient of friction. Rear wheels are typically conventional go-kart rims with rubber tires that have plastic sleeves installed around the rubber tire. The secondary rear wheels can also be smaller wheels such as skateboard wheels. The primary rear wheels and secondary rear wheels could also be molded from solid rubber or plastic.

In operation and use variable traction device 10 gives a drift vehicle driver a greater level of control over the traction of the rear end of the drift vehicle. It allows the operator to lower the traction of the rear wheels to induce a sideways drift of the vehicle when the driver wants to drift, but also gives the driver the ability to have a high amount of traction when needed for cornering or braking in emergency situations. The drift vehicle operator pulls or pushes on the actuator lever 30 which in turn raises and lowers the secondary rear wheels 22. When the secondary rear wheels are in the fully retracted or up position, all of the vehicle weight is on the primary rear wheels 20 (FIG. 2A). When the secondary rear wheels 22 are in the fully deployed position, all of the vehicle weight is on the secondary rear wheels 20 (FIG. 2B). Depending upon how much force is applied to the actuator lever 30, the weight of the vehicle may be continuously varied between the primary rear wheels 20 and the secondary rear wheels 22, thus allowing the operator to continuously vary the traction of the rear wheels with the road surface. When the weight of the vehicle is on the wheels made of plastic, the vehicle will slide or drift, when the weight of the vehicle is on the rubber wheels, the vehicle will grip

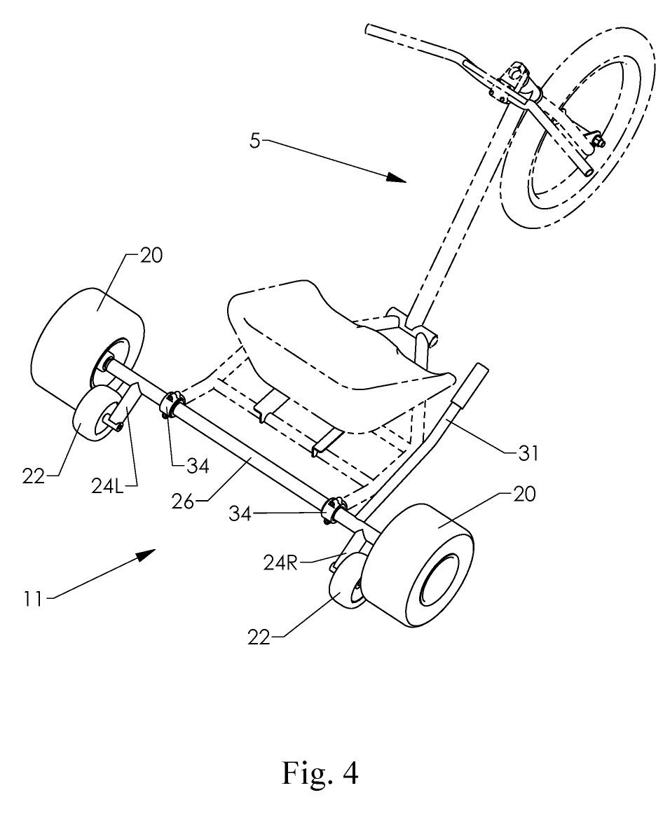

FIG. 4 depicts an alternative embodiment of a variable traction device 11. This embodiment is similar to the embodiment of FIGS. 1-3, with the exception that the actuator lever is a hand lever 31 directly attached to the rear axle 26 (FIG. 4) thus eliminating pushrod 28 and bell crank 32 (FIG. 1-3).

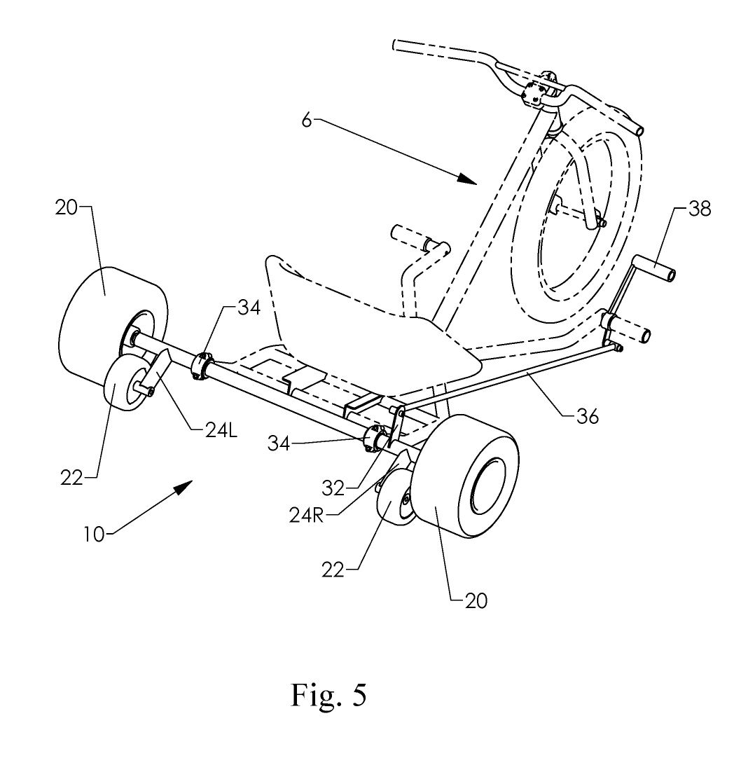

FIG. 5 depicts another alternative embodiment of the invention. This embodiment is similar to the embodiment of FIGS, 1-3, with the exception that the actuator lever is a foot pedal 38. The driver uses his/her foot to actuate the secondary rear wheels 22. Foot pedal 38 is pivotally mounted to a conventional three-wheeled drift vehicle chassis 6. When foot pedal 38 is depressed, pushrod 36 pushes on bell crank 32 rotating rear axle 26 thereby lowering secondary rear wheels 22 in the same manner as the variable traction device 10 shown in FIGS. 1-3.

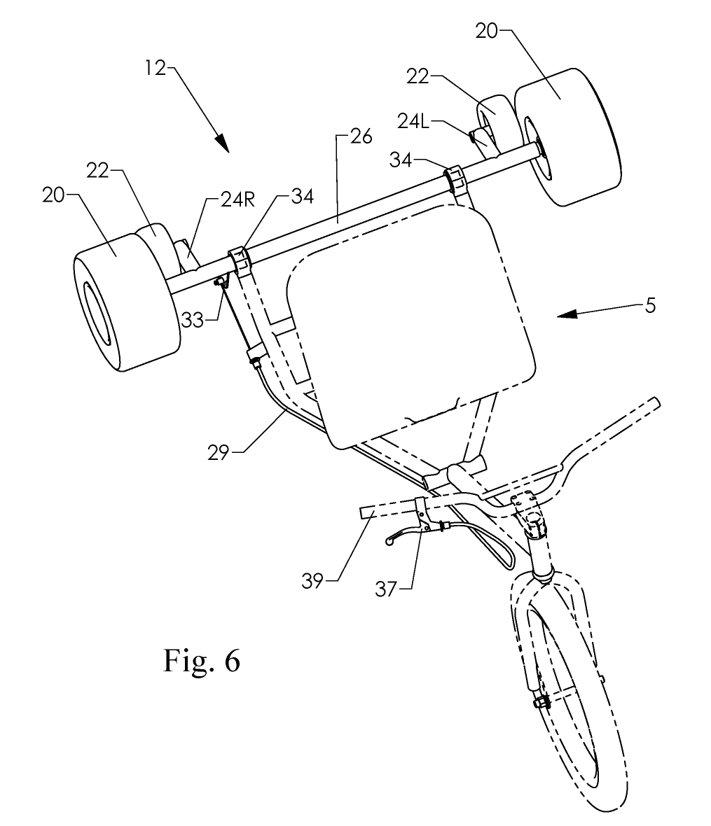

FIG. 6 depicts another alternative embodiment of the variable traction device 12. This embodiment is similar to the embodiment of FIGS. 1-3, with the exception that the actuator lever is a hand lever 37 mounted on the handlebars 39 of a conventional three-wheeled drift vehicle 5. In the illustrated embodiment, a cable 29 operably links hand lever 37 with a bell crank 33 to provide a linkage that rotates rear axle 26 when hand lever 37 is operated, thereby lowering secondary rear wheels 22 in the same manner as the variable traction device 10 shown in FIGS. 1-3.

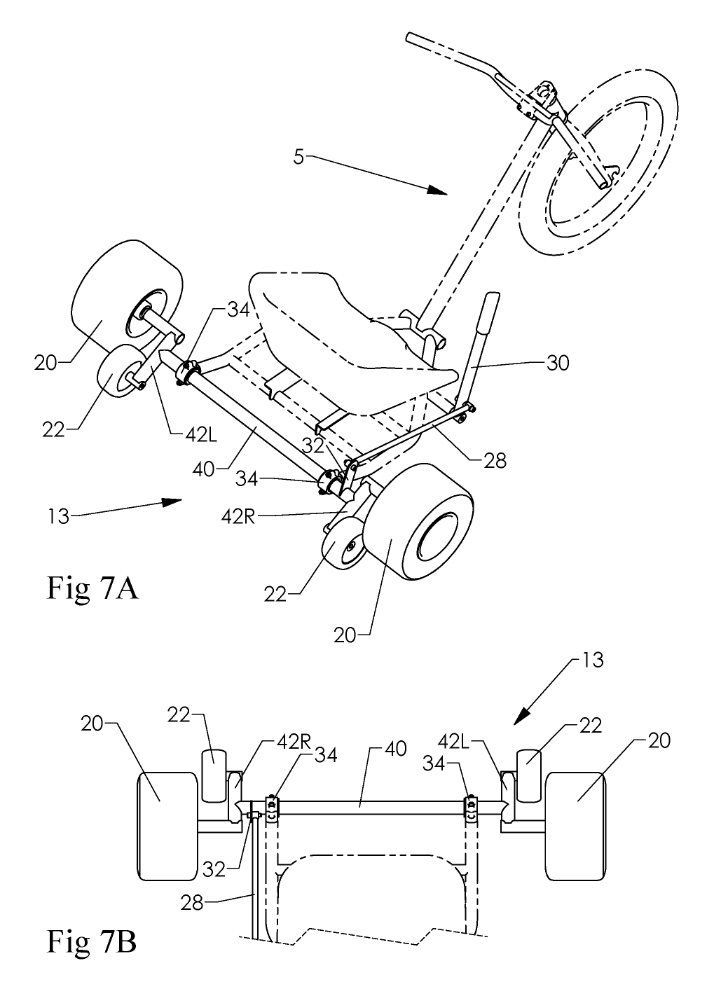

FIGS. 7A-7B depicts another alternative embodiment of the invention. A variable traction device 13 is shown according to an embodiment of the invention on a conventional three-wheeled drift vehicle 5 (shown in phantom line). Variable traction device 13 is similar to the variable traction device 10 in FIGS. 1-3, with the exception of the placement of swing-arms 42L and 42R. Swing-arms 42L and 42R attach to the opposite ends of a rear axle 40 and extend laterally in both front and rear directions thus giving the swing-arms two distal ends. In the illustrated embodiment, the pair of primary rear wheels 20 is rotatably attached to the front distal end of the swing-arms 42L and 42R, and the pair of secondary rear wheels 22 is rotatably attached to the rear distal end of the swing-arms 42L and 42R as shown in the drawing. Mounting swing-arms 42L and 42R to axle 40 in this manner distributes the weight of the vehicle approximately equal to both primary rear wheels 20 and secondary rear wheels 22 when no pressure is applied to the actuator lever 30. When actuator lever 30 is pulled or pushed, the vehicle weight is biased either to the primary rear wheels 20 or to the secondary rear wheels 22.

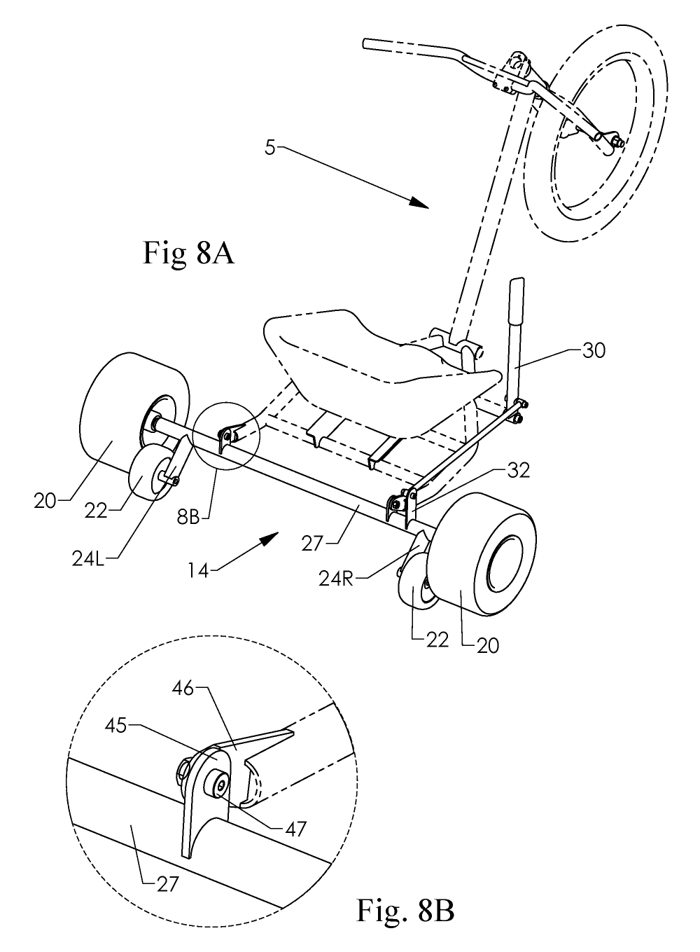

FIGS. 8A-8B shows another alternative embodiment of a variable traction device 14. This embodiment is similar to the embodiment of FIGS. 1-3, with the exception that the bearings 34 (FIGS. 1-3) have been replaced by axle tab 45, chassis tab 46 and shoulder screw 47 (FIG. 8B). Axle tab 45 and chassis tab 46 are flat plates having aligned openings for receiving shoulder screw 47.

Axle tab 45 is attached to rear axle 27, chassis tab 46 is attached to the chassis of drift vehicle 5. Shoulder screw 47 passes through tabs 45 and 46 pivotally securing rear axle 27 to drift vehicle chassis 5. The advantage of pivotally mounting the rear axle 27 in this manner is that the variable traction device 14 is cheaper to manufacture with the elimination of bearings 34 (FIGS. 1-3).

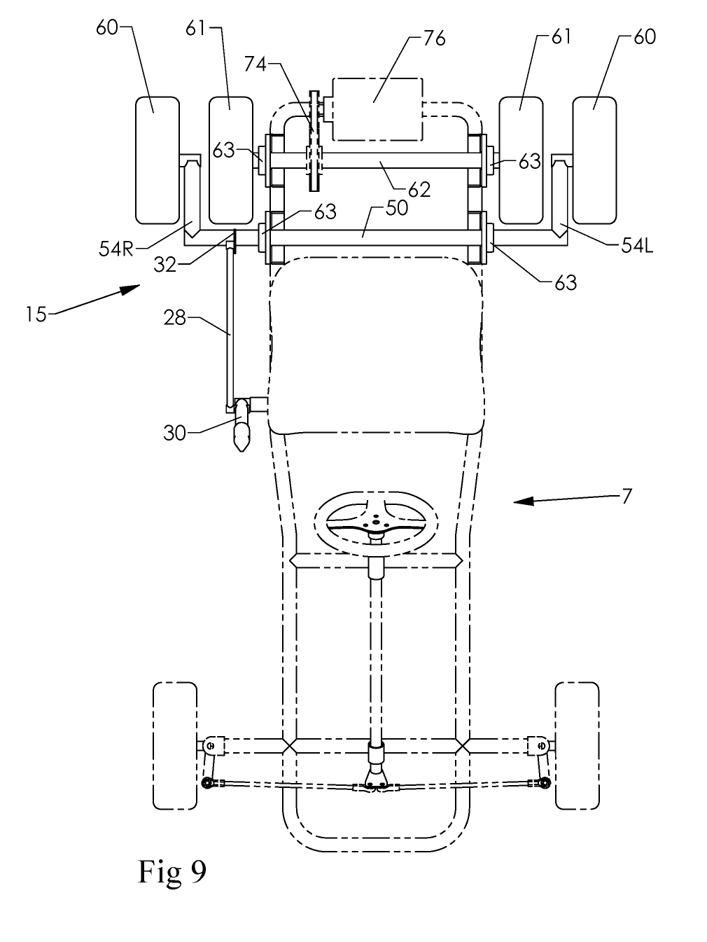

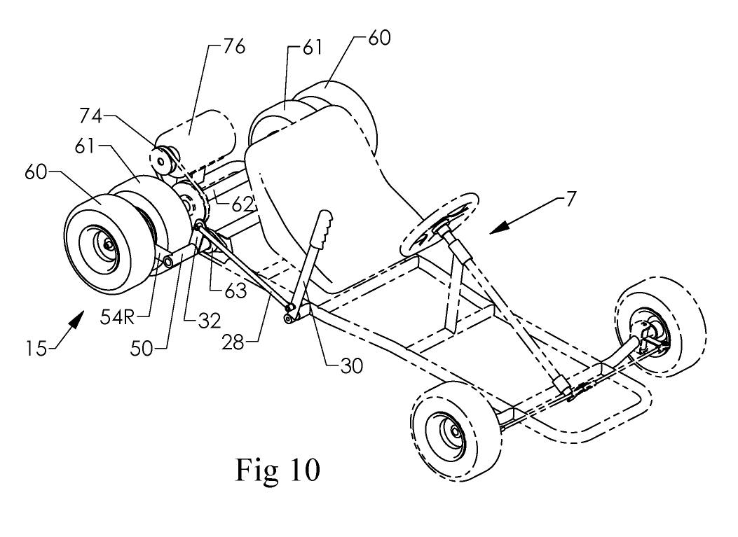

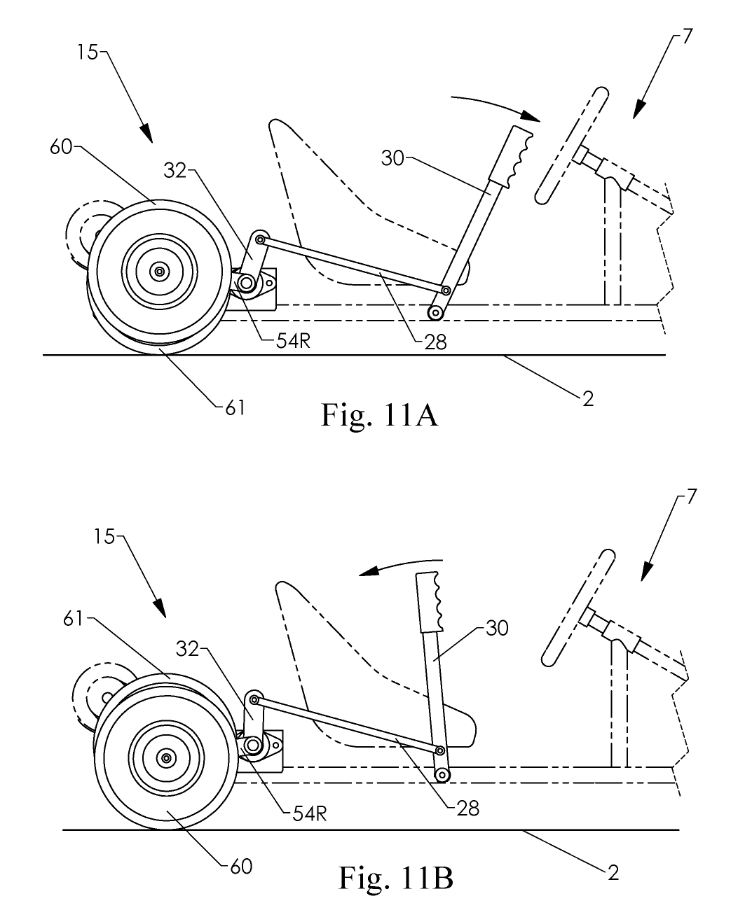

FIGS. 9, 10 and 11A-11B show another alternative embodiment of the variable traction device. A variable traction device 15 is shown according to an embodiment of the invention on a conventional four-wheeled drift vehicle 7 (shown in phantom line). The variable traction device 15 includes a rear axle 62 with primary rear wheels 61 attached to opposite ends of the rear axle 62 wherein the primary wheels may be driven by a motor. Rear axle 62 is rotatably mounted to the drift vehicle 7 with bearings 63 journaling the axle. Variable traction device 15 further includes elongated swing-arm axle 50 that is pivotally secured to the drift vehicle 7 with bearings 63 journaling the swing-arm axle 50. Swing-arms 54L and 54R are attached at opposite ends of the swing-arm axle 50 and are preferably positioned close to primary rear wheels 61 but with enough clearance for the primary rear wheels 61 to rotate. Secondary rear wheels 60 are rotatably mounted to the distal ends of swing-arms 54L and 54R. The conventional four-wheeled drift vehicle 7, shown FIGS. 9-10 and 11A-11B, also includes a motor 76 and a belt/chain 74 for drivingly connecting the engine to the rear axle 62. FIGS. 11A and 11B show the movement of the secondary rear wheels 60 in relation to the movement of the actuator lever 30. FIG. 11A shows the secondary rear wheels 60 in the fully retracted position, and FIG. 11B shows the secondary rear wheels in the fully deployed position. When actuator lever 30 is pulled backwards, pushrod 28 pushes on bell crank 32 rotating swing-arm axle 50 thereby rotating the distal end of swing-arms 54L and 54R downward, lowering secondary rear wheels 60 to the ground 2. When actuator lever 30 is pulled with sufficient force, primary rear wheels 61 are lifted off of the ground 2 by the secondary rear wheels 60, as shown in FIG. 11B. In the illustrated embodiment, the primary rear wheels 61 are made from a high coefficient of friction material such as rubber, and the secondary rear wheels 60 are made from a low coefficient of friction material such as plastic.

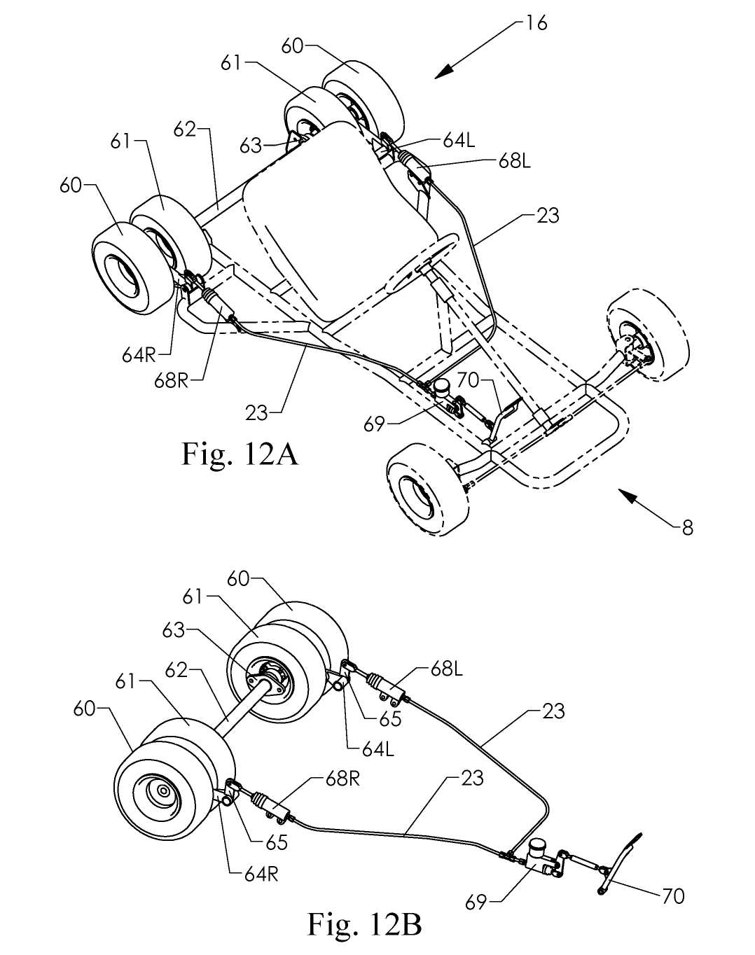

FIGS. 12A and 12B show another alternative embodiment of the variable traction device. A variable traction device 16 is shown according to an embodiment of the invention on a conventional four-wheeled drift vehicle 8 (shown in phantom line in FIG. 12A and not shown in FIG. 12B). Variable traction device 16 includes an elongated rear axle 62 with primary rear wheels 61 attached to opposite ends of the rear axle 62. Rear axle 62 is rotatably mounted to the drift vehicle 8 with bearings 63 journaling the axle. Variable traction device 16 further includes a set of swing-arms 64L and 64R which are pivotally attached to drift vehicle 8 (FIG. 12A). Secondary rear wheels 60 are rotatably mounted to the distal end of swing-arms 64L and 64R. Foot pedal 70 is pivotally attached to drift vehicle 8 and is operably linked to hydraulic master cylinder 69. Master cylinder 69 is fluidly coupled through hydraulic line 23 to a set of hydraulic slave cylinders 68L and 68R. Slave cylinders 68L and 68R are operably linked to a pair of bell cranks 65 affixed to swing-arms 64L and 64R at a right angle to the swing-arms longitudinal axis. Thus, pushing on foot pedal 70 lowers secondary rear wheels 60 to the ground and with enough force will raise primary rear wheels 61 off the ground.

While the present invention has been described in terms of particular embodiments and applications, in both summarized and detailed forms, it is not intended that these descriptions in any way limit its scope to any such embodiments and applications, and it will be understood that many substitutions, changes and variations in the described embodiments can be made by those skilled in the art without departing from the spirit of this invention,. Although specific features of the invention are shown in some drawings and not in others, however, this is for convenience only as each feature may be combined with any or all of the other features in accordance with the invention.

The invention claimed is:

1. A variable traction device for varying the traction of rear wheels on a drift vehicle, comprising:
(a) a rear axle pivotally mounted to a drift vehicle chassis;
(b) a pair of primary rear wheels rotatably mounted to the rear axle;
(c) a pair of spaced apart swing-arms rigidly coupled to the rear axle at a location proximate to the primary wheels;
(d) a pair of secondary rear wheels rotatably mounted to the distal end of the swing-arms, the secondary rear wheels having a substantially different coefficient of friction than the primary wheels; and
(e) an actuator lever positioned within reach of a driver and means for operably linking the actuator lever to the rear axle,
whereby movement of the actuator lever rotates the rear axle thus raising and lowering the secondary rear wheels.

2. The variable traction device of claim 1, wherein the actuator lever is a hand lever positioned on the drift vehicle chassis within reach of the driver.

3. The variable traction device of claim 1, wherein the actuator lever is a hand lever mounted on the handlebars or steering wheel of the drift vehicle.

4. The variable traction device of claim 1, wherein the means for operably linking comprises a cable operably connecting the actuator lever to a bell crank attached to the rear axle.

5. The variable traction device of claim 1, wherein the actuator lever is a foot pedal pivotally mounted to the drift vehicle chassis within reach of the driver.

6. The variable traction device of claim 1, wherein the means for operably linking comprises a push rod operably connecting the actuator lever to a bell crank attached to the rear axle.

8. The variable traction device of claim 1, wherein the means for operably linking comprises a hand lever attached directly to the rear axle perpendicular to the rear axle axis of rotation.

7. The variable traction device of claim 1, wherein the means for operably linking comprises a hydraulic master cylinder fluidly coupled through a hydraulic line to a hydraulic slave cylinder operably connected to a bell crank attached to the rear axle.

9. The variable traction device of claim 1, further comprising a chassis tab connected to the drift vehicle chassis, an axle tab connected to the rear axle, and a shoulder screw passing through openings in the tabs whereby the rear axle is pivotally secured to the drift vehicle chassis.

10. A variable traction device for varying the traction of the rear tires of a drift vehicle, comprising:
(a) a pair of primary rear wheels;
(b) a pair of swing-arms pivotally attached to the drift vehicle for rotational movement with respect to the drift vehicle between a retracted and deployed position;
(c) a pair of secondary rear wheels rotatably mounted to the distal end of the swing-arms, the secondary rear wheels having a substantially different coefficient of friction than the primary rear wheels; and
(d) an actuator lever positioned within reach of a driver, the actuator lever being operably linked to the swing-arms,
whereby movement of the swing-arms between the retracted and deployed position may be achieved by manipulation of the actuator lever.

11. The variable traction device of claim 10, wherein the actuator lever is a hand lever pivotally attached to the drift vehicle within reach of a driver.

12. The variable traction device of claim 10, wherein the actuator lever is a hand lever attached to the handlebars of the drift vehicle.

13. The variable traction device of claim 10, wherein the actuator lever is a foot pedal pivotally attached to the drift vehicle within reach of the driver.

14. The variable traction device of claim 10, wherein the actuator lever is linked to the swing-arms with a cable.

15. The variable traction device of claim 10, wherein the actuator lever is linked to the swing-arms with a push rod linkage.

16. The variable traction device of claim 10, wherein the actuator lever is fluidly linked to the swing-arms with a hydraulic master cylinder and slave cylinder.

17. The variable traction device of claim 10, wherein the pair of swing-arms are connected together with an elongate shaft.

18. The variable traction device of claim 10, wherein the primary rear wheels are rotatably mounted to the drift vehicle chassis.

19. The variable traction device of claim 10, further comprising an axle rotatably mounted to the drift vehicle chassis, and a motor drivingly connected to the axle, wherein the primary rear wheels are affixed to the axle.

20. A variable traction device for alternating the weight of a drift vehicle between two sets of rear wheels which have a dissimilar coefficient of friction to vary the traction of a drift vehicle with the road surface, comprising:
(a) a pair of primary rear wheels rotatably mounted to the drift vehicle;
(b) a pair of secondary rear wheels having a substantially different coefficient of friction than the primary wheels, the secondary rear wheels being connected to the drift vehicle via a swing-arm; and
(c) an actuator lever mechanically linked to the swing-arms,
whereby manipulation of the actuator lever varies the weight of the drift vehicle between the primary rear wheels and the secondary rear wheels.
